(19) United States
(12) Patent Application Publication
(10) Pub. No.: US 2012/0256006 A1
(43) Pub. Date: Oct. 11, 2012

(54) Secure package for transaction card assembly

(76) Inventor: Stephen E. Schmitt, Winnetka, IL (US)

(21) Appl. No.: 13/506,290

(22) Filed: Apr. 7, 2012

Related U.S. Application Data
(60) Provisional application No. 61/516,797, filed on Apr. 7, 2011.

(51) Int. Cl. G06K 19/06; B29C 65/48; G06K 19/00

(52) U.S. Cl. 235/493; 235/487; 156/182

(57) ABSTRACT

A package assembly contains a transaction card coupled to a tamper indicator where the tamper indicator is bonded to the package assembly in a manner that tampering will cause visible damage or deformation to the tamper indicator. The tamper indicator may be an account activation element uniquely correlated with the transaction card.

### FIELD OF THE INVENTION

This invention relates generally to the packaging, display, and security of transaction cards activated at the point of sale.

### BACKGROUND OF THE INVENTION

Within the last three decades there has been a revolution in the use of transaction cards. Transaction cards are used for payment in many retail situations, in retail stores, for telephone services, for on-line purchases, for music downloads, for ATM usage, and the like. Such cards are subject to fraud with the thief removing a valid gift card from a removable element used to activate the card and reconnecting a fraudulent transaction card. By swapping a valid card with an invalid card, the thief will end up with the valid card and the consumer making the purchase will end up with an invalid card.

### SUMMARY OF THE INVENTION

This invention is related to a package assembly, transaction assembly, tamper detection system or method, and/or manufacturing method and packaging system, including but not limited to, for example, for gift cards, telephone service cards, music download cards, on-line purchase cards, ATM cards or the like.

### BRIEF DESCRIPTION OF THE DRAWINGS

FIG. 1 is a front view of a transaction card with a removable activation element where the removable element is located below the transaction card.

FIG. 2 is a front view of a transaction card with a removable activation element where the removable element is located above the transaction card.

FIG. 3 is a back view of a transaction card with removable activation element with bar codes used for both activation and redemption.

FIG. 4 is a back view of a variation of a transaction card with removable activation element with bar codes used for both activation and redemption.

FIG. 5A is an exploded view of a variation of a package assembly.

FIG. 5B is a side cut away view of the package assembly of FIG. 5A.

FIG. 5C is a plan view of an exterior side of the front carrier of the package assembly of FIG. 5A.

FIG. 5D is a plan view of an interior side of a front carrier of FIG. 5C

FIG. 5E is a plan view of an exterior side of a back carrier.

FIG. 5F is a plan view of an interior side of a back carrier.

FIG. 5G is a plan view of the back of a package assembly of FIG. 5A.

FIG. 6 is a side cut away view of a variation of a package assembly.

FIG. 7A is a back plan view of the back carrier of a variation of a package assembly.

FIG. 7B is a front plan view of the back carrier of FIG. 7A.

FIG. 8A is a side cut away view of a variation of a package assembly.

FIG. 8B is a back plan view of a variation of the front carrier of the package assembly of FIG. 8A.

FIG. 8C is a front plan view of a variation of the back carrier of the package assembly of FIG. 8A.

### DETAILED DESCRIPTION OF THE INVENTION

A transaction card, as described herein may include, for example, a card that may be used in a business transaction with a party willing and able to accept the card, for example, in payment for a purchase. Examples of such cards include, but are not limited to gift cards, debit cards, loyalty cards, ticket cards, prepaid cards, phone cards, membership cards, and others. Typically such cards are wallet sized and made of plastic but other sizes and materials are often used. Transaction cards typically have a unique account number associated with each card.

Some transaction cards are sold by a particular retailer and can only be used at a location of that same retailer.

Many other retail transaction cards are sold to consumers in store locations other than the store location of the retailer issuing the cards. These transaction cards are commonly known as third party activated transaction cards. The transaction cards are issued by issuing retailer and sold by a third part retailer, at one of the third party retailer's locations. Then, at a later date, the transaction card is redeemed or used at the issuing retailer, e.g., store location or web site. An example might be the sale of a gift card issued by a home improvement retailer at a third party grocery retailer. Another example might be the sale of music download card issued by an on-line internet retailer and sold at a third party drug store retailer. These and similar types of cards will be referred to herein as a third party transaction cards.

Often the transaction systems of the card issuer and the third party retailer are incompatible and require that a unique set of activation data be used to accept the transaction into the point of sale computers at the third party retailer while a different unique set of usage data must be used in the point of sale computers at the card issuer.

Each third party transaction card has associated with it unique activation data and unique usage data. These two data elements are stored in a cross reference database that allows a computer at the card issuer, the third party retailer, or a transaction processing service provider to receive the unique activation data and then perform the required action to the account associated with the usage data. For example, for a gift card, the action required upon activation might be transferring funds into that account, for a membership card the action might be recording the activation of the card in a customer database. “Activation” as used herein including with “activation device” “activation element’ and “activation data” includes mechanisms elements or devices that are configured to be read by a reader to thereby activate or valuate an account. In some cases unique activation data may be considered unique valuation date. Where an account is activated and/or value is loaded to it. Usage data by contrast corresponds to the use of the valuation loaded to the account. An account activation element may include for example a unique bar code, an account number or any other readable element configured to be read to activate or valuate a transaction device such as a transaction card.

Many third party activated gift cards have both activation and redemption (usage) transaction data on the same planar surface. For some third party activated transaction cards both the activation and redemption (usage) elements may be written or located on the transaction card in a human readable or machine readable form such as a bar code, and encoded magnetic stripe, an embedded radio frequency device, or printed or embossed numbers or codes or other readable elements. Often this can cause confusion and waste time at the point of sale as the retail associate must determine which data is required for activation or which data is required for usage. Additional problems can arise when the point of sale devices used to read the transaction data cannot determine which data set is the correct data set. Additional problems can arise when the point of sale transaction device, such as bar code reader, reads both activation and usage data at the same time. Additional problems can arise when the limited size of the transaction card does not allow sufficient space for both activation and usage data and terms and conditions or other consumer information that may be required.

Some card issuers solve this problem by placing the activation data on a package and placing the usage data on the transaction card. The transaction card is then attached to the package that carries the correct cross referenced activation data. Thieves can attack this package by swapping a valid transaction card with an invalid transaction card.

Another solution to the problem of having both activation and redemption data on the same planar surface has been to create a transaction card assembly that includes a transaction card and a detachable activation device. The transaction card contains only the data required for usage, reloading and other types of transactions at the card issuing retailer. The detachable activation device contains only the data required by the third party retailer. The assembly has an interface or attachment method where the transaction card and the activation device can be separated from one another. The activation portion is typically identified with instructions to the consumer to detach and discard the activation device after purchase.

The transaction card with activation device assembly presents advantages for manufacture as well in that the encoding of both the activation data and the usage data can take place in a single step and do not require the careful matching of a unique transaction card to a package containing the cross referenced unique activation data. However, these cards are susceptible to tampering as well.

In an effort to make the purchase of gift cards, telephone service cards, music download cards, on-line purchase cards, ATM cards or the like easier, many retailers display the transaction card assembly in an inactive state in an unsecured location in the store. In this unsecured location, the card assembly is subject to predations of thieves who will detach the activation device from a valid transaction card and reattach the activation device to an invalid transaction card. When the consumer purchases the altered assembly they will have the invalid transaction card and the thief will have, the valid transaction card.

To prevent this from occurring, some gift card issuers package the assembly in a paper package formed by folding paper around the assembly and gluing it closed. In such packages, the entire assembly is susceptible to tampering as the package may be opened and re-glued shut without readily visible evidence of tampering. While the assembly may be attached to the package with a fugitive glue, such glue is easily separated from the package or assembly without readily visible damage or change to the packaging. Fugitive glue is used in such situations for the purpose of making the assembly removable without damaging it. At the point of sale, the consumer or the store clerk must manipulate or open the package to access the activation device and an activation element for activation.

Another way used to prevent the thieves from swapping the activation device is to place a security code across the interface between the transaction card and the activation device. This security code is typically a code number, an image, or a bar code. The consumer or store clerk is instructed to examine the security code before purchasing the package to determine if it has been altered. Most consumers and store clerks do not understand the instructions or take the time to examine the security code so this is not a very effective theft prevention solution. The alterations made by the thief are not easy to detect.

Many existing packages are used to protect prepaid debit cards such as prepaid Visa, MasterCard, or American Express cards. These packages typically are secured using a heat sealed adhesive around the perimeter of the package. However, in all cases, they provide a package for a transaction card while activation data or elements are positioned is exterior to the packaging. Thus tampering by removing a card and replacing it with a different card is still a potential problem that may go undetected. In addition such a configuration requires additional manufacturing steps to match a bar-coded or encoded carrier to the transaction card on the inside of the package.

Another method for preventing the fraudulent swapping of the activation device is to place a matching security code on both the transaction card and activation device. The consumer and store clerk are instructed to compare the two codes prior to purchase. While it is easier to instruct a consumer or store clerk to match two codes than it is to instruct them to look for alterations to a single code it is still an extra step that many consumers and store clerks do not take prior to purchase. Thus the swapping actions of the thief may not be detected.

Many food, beverage, medicines, and other consumer packaged goods are protected by tamper evident packaging such as, safety seals and enclosures. While permanent glues and the like have been used to seal such packages, they do not typically require access to a product at point of sale.

It is hypothesized herein that a consumer who has been typically shown to be more likely to look at a consumer good packed to see if there has been tampering, is therefore likely notice the tampering than they would be to notice that code numbers have been altered.

Many existing packages used for packaging transaction card assemblies are formed by folding and gluing paper around the transaction card in various configurations. All of these packages inconveniently require the consumer to remove glue from the transaction card and while this glue is often hot melt fugitive glue, in many cases the glue does not remove cleanly. In addition, without a continuous seal of the front carrier to the back carrier around the entire perimeter of the package, a thief can open and reclose the package and swap valid and invalid cards without detection.

Variations of the assembly and methods described herein may provide for more readily detectable tampering of transaction cards by thieves.

Variations of the assembly and methods described herein may provide a more secure transaction card package at least in part, by sealing a transaction card assembly between two carrier panels.

Variations of the assembly and methods described herein may provide a more secure transaction card package at least in part by sealing a transaction assembly and/or transaction card completely about its perimeter.

Variations of the assembly and methods herein may provide a bond formed about the perimeter of a transaction card in such a way as to allow the consumer to remove the transaction card from the activation device by detaching at the attachment element while leaving the transaction card free of any adhesive residue and easy to remove. According to a variation, the bond may be formed by a permanent adhesive as set forth herein. A permanent adhesive as used herein is selected or designed to not fully or readily release from surface, i.e., to create visible surface damages such as, e.g., cracking, fiber tear, splitting, flaking, delaminating, significant loss of print image, or irreversible damage. Fugitive glue on the other hand, has a lower peel strength than shear strength so that it can readily peel (even if left as residue) while otherwise sticking to a surface.

Variations of the assembly and methods herein may provide a bond formed about the transaction card allowing removal of the transaction card while the activation device remains behind and/or is bonded or attached to the packaging.

Variations of the assembly and methods herein may provide for the use of a permanent adhesive to attach an activation device or tamper detection element to a packaging assembly wherein the activation device or tampering element is removably coupled to the transaction card. The transaction card may them be removed from the packaging assembly free from damage from permanent glue. Tampering indication elements herein may or may not comprise activation devices. Tamper indication elements and activation elements may be configured to be visibly disturbed or damaged upon attempted separation from one or more packaging elements bonded thereto.

Variations herein describe particular packaging, account and transaction elements having particular functions where the elements are positioned with respect to other elements and or are assembled, attached, connected or bonded in a particular manner that provides evidence of tampering and may prevent a thief from stealing as described herein.

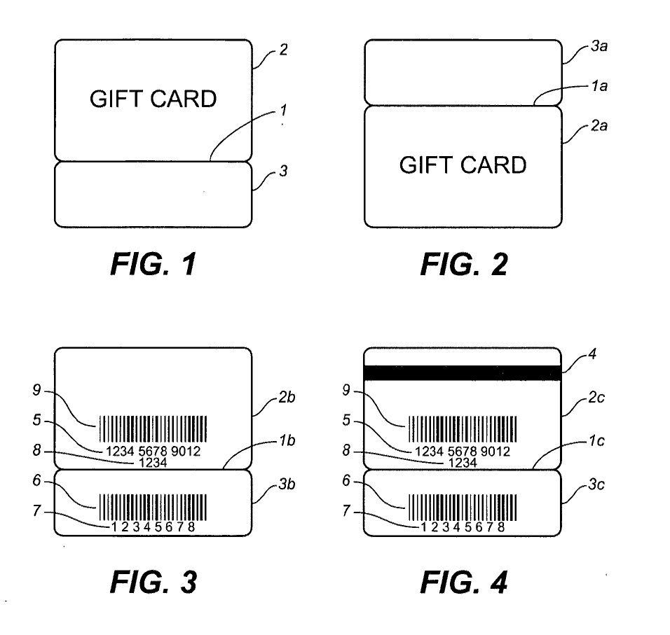

FIGS. 1-4 show examples of transaction cards with an activation device that may be used in an assembly or method in accordance with one or more variations of the invention. In FIG. 1, the transaction card 2 and activation device 3 are removably coupled with an attachment element or mechanism 1, e.g., a score or perforation line in the solid substrate on which the cards are printed or another attachment element. The activation device 3 may be coupled, for example at the bottom of the transaction card as shown in FIG. 1. The activation device may include an activation element comprising a readable element having a unique activation function for the transaction device or card. An activation element may include scannable codes, pin numbers and/or other activation structures thereon.

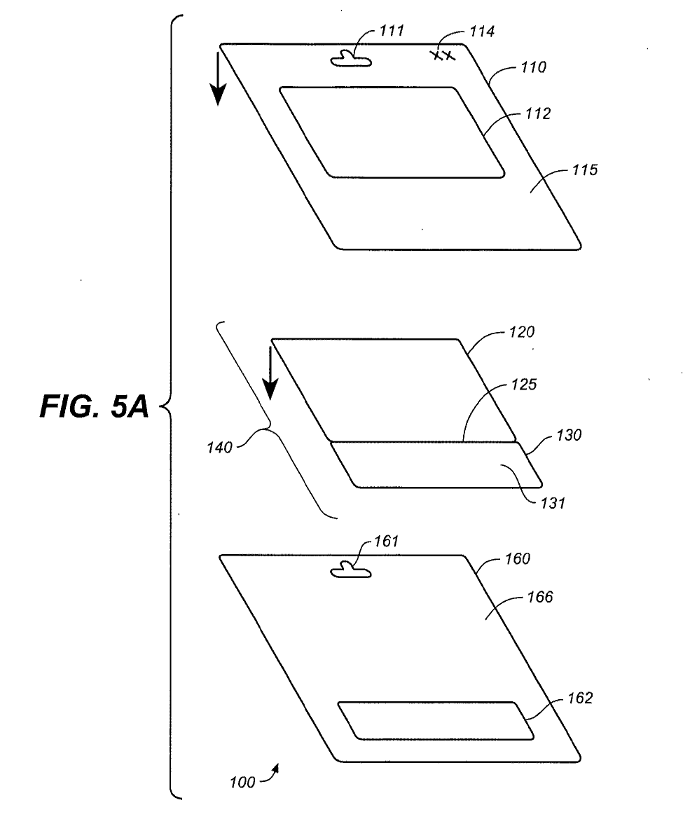

Similarly in FIG. 2 a transaction card 2a is shown with an activation device 3a that is removably coupled to or at the top of the transaction card 2a with an attachment element 1a as shown in FIG. 2. The present invention allows for the activation devices to be attached to any edge of the transaction card.

Transaction cards typically used are rectangular in shape and 2.125″ by 3.375″. However, the present invention accommodates most shapes or sizes of transaction card and activation devices that may be desired. An attachment element coupling the transaction card to the activation device may be formed, for example, by a adding a score, break, perforation, weak area to a single piece of substrate thus defining the separation of the substrate into a transaction card portion and an activation portion. Other attachment elements or mechanisms may be used as well. The activation device may be directly or indirectly coupled to the transaction card. Non-limiting attachment elements may be used and may include, for example, adhesive, rivets, fasteners, or tamper evident adhesive tape.

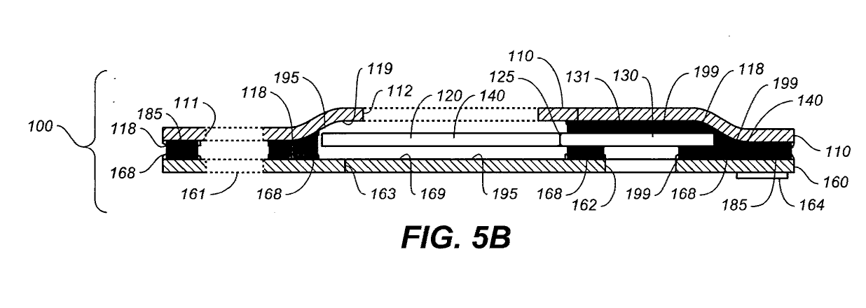

FIG. 3 is a plan view of the back of assembly transaction card 2b and an activation device 3b coupled together with attachment element 1b. An activation element 6 comprising a bar code may encode unique activation data on the activation device 3b. The transaction card 2b uses the bar code 9 and/or the account number 5 to encode the usage data. FIG. 3 also shows an optional security PIN number 8. One advantage to this assembly is that the transaction card and the activation device can be bar coded by one print head at the same time. This provides for manufacturing efficiencies when compared to transaction card assemblies that have a transaction card affixed to a carrier encoded or bar-coded with activation data.

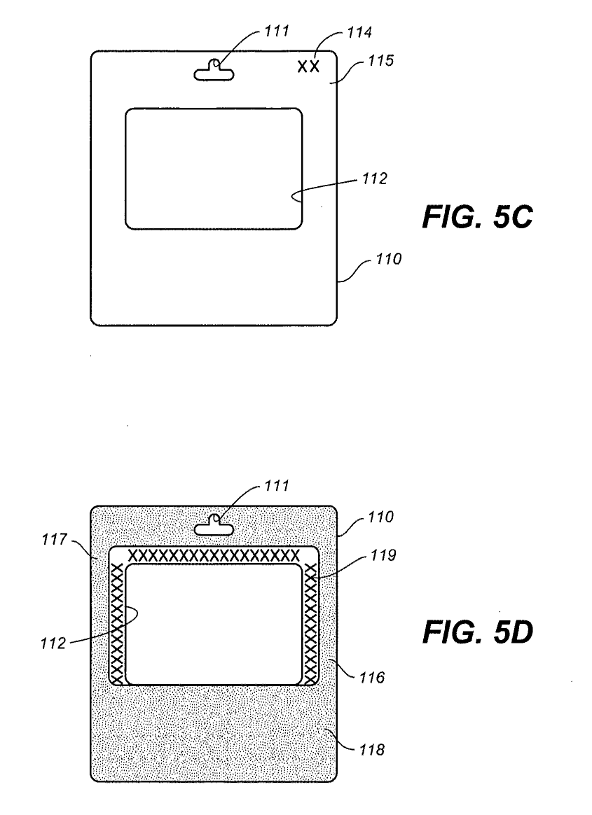

FIG. 4 shows a transaction card 2c and an activation device 3c coupled with an attachment element 1c. This assembly may use an activation element comprising as a bar code 6 or an account number 7 on the activation device to encode the activation data. The transaction card 2c has its usage data contained in a unique usage identification element for example, comprising an account number 5, a bar code 9, and/or a magnetic stripe 4.

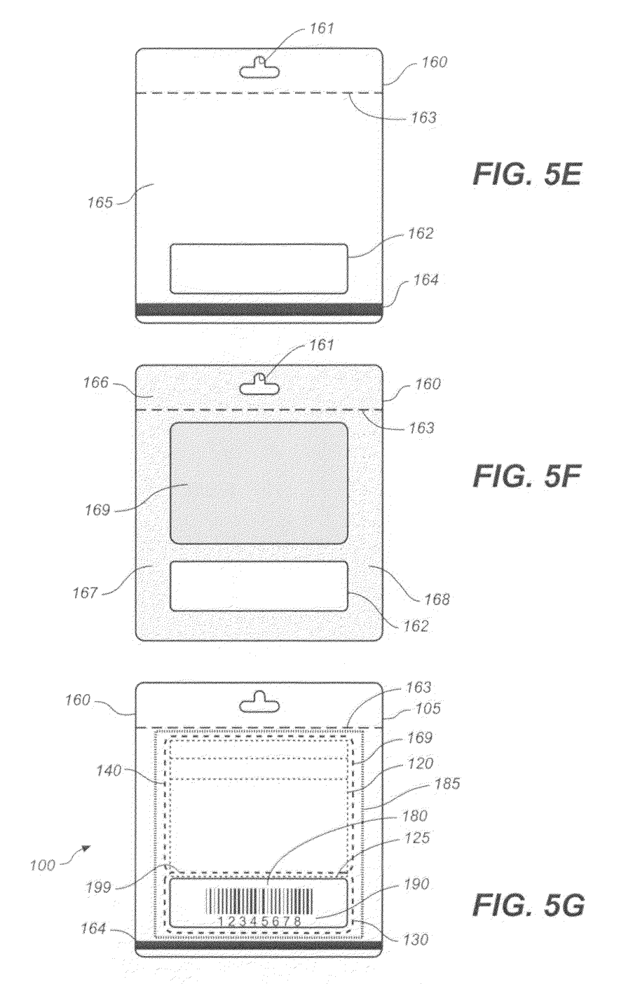

FIGS. 5A to 5G illustrate a variation of a package assembly 100 and corresponding method. A transaction card 120 is removably coupled to activation device 130 by way of attachment element 125, to form a transaction assembly 140. The transaction assembly 140 is positioned on the back carrier 160. A front carrier 110 is positioned upon the back carrier 160 and then sealed, bonded, attached or otherwise coupled to form an enclosure 195 that securely contains the transaction assembly 140 between the front carrier 110 and the back carrier 160. Alternatively the transaction assembly 140 may be first positioned on the front carrier 110 and then the back carrier 160 may be positioned over the front carrier 110 prior to sealing together. A bond or seal may be formed with an adhesive such as a permanent adhesive, (such as HB Fuller PHL 4165), by heat-sealing an adhesive (such as Solucote 105li-3-45), by ultrasonic or radio frequency welding of materials or films from which the assembly may be constructed in whole or in part, and/or by UV curing a UV curable material or film, or in any such manner that will make tampering evident to one who inspects the package assembly 100. According to a variation, a continuous seal 185 may be formed between the back carrier 160 and front carrier 110 and about the perimeter of the transaction card 120 and/or the transaction card assembly 140.

Tampering to detach and swap a valid transaction card with an invalid transaction card may, for example be evident by creases or tears in the front carrier 110 or the back carrier 160, tearing of fibers of the packaging and/or other visually apparent damage to the surfaces of the packaging. This may occur due to sealing or bonding with a permanent adhesive.

Additionally, according to one variation, when the front carrier 110 and the back carrier 160 are sealed together, a seal or bond 199 may also be formed between the activation device 130 and the front carrier 110 and/or back carrier 160 that will result in the apparent tearing of fibers and/or other visually apparent damage to the surface (which may included printed matter) or substrate of the activation device when that bond is broken.

According to variations, the bond 199 may be formed with an adhesive such as a permanent adhesive, or by an energy formed seal e.g., by heat-sealing an adhesive, by ultrasonic, radiofrequency or other energy welding of materials or films from which the assembly may be constructed in whole or in part, or and/or by UV curing a UV curable material or film, or in any such manner that will make removal of the activation device 130 or its separation from the transaction card 120, evident to one who inspects the package assembly 100. The bond 199 may or may not also form a portion of the continuous seal 185.

Neither the seal 185 nor bond 199 impinges on the transaction card 120, leaving the transaction card 120 free to be removed from the package 100 when it is detached from the activation device 130. Thus, the transaction card 120 is removable from the activation device 130 by detaching at the attachment element 125, and free of any adhesive residue and easy to remove while the activation device 130 remains bonded to the packaging.

The front carrier 110 may have a die cut or other window 112 to show a portion of the transaction assembly 140 which may include for example, at least a portion of the transaction card 120. The back carrier 160 may have an die cut window 162 to reveal one or more activations elements, e.g., bar codes 180 and/or activation account numbers 190, for example, similar to activation bar codes, activation account numbers, and/or other activation elements, shown in FIGS. 1-4. According to a variation, an attachment device that attaches the transaction card to the activation device requires manipulation that will cause evidence of tampering. Such manipulation may cause evidence of tampering by disturbing the continuous seal or bond, or of the seal 199 and activation device where they are attached which, in turn may cause damage to the packaging or transaction element. It is believed that this will deter a thief from stealing the card because of the effort and difficulty in repairing the packaging. According to a variation, a significant angular deflection or bending (e.g., of 10 degrees or more) of the transaction card from the plane of the activation device may be required to remove the transaction card from the activation device or tampering indicator thus likely resulting in evidence of tampering. An attachment device that requires significant angular deflection of the transaction card for removal, is more likely to show signs of tampering in that the thief will have to dissociate the continuous bond 185 along a longer portion of the length of that bond in order to remove the valid transaction card from the activation device and replace it with an invalid transaction card.

Referring to FIG. 5C an optional sombrero hanging hole 111 and an optional window 112 are provided through the exterior side 115 of the front carrier portion to the interior side 116 of the front carrier 110. The exterior side 115 may be printed with information 114 which may, for example, describe the type, value or features of the transaction card inside. In a finished package assembly 100 the front carrier exterior side 115 is typically visible to the consumer.

Referring to FIG. 5D the interior side 116 of the front carrier 110 is shown. This side 116 is not visible to the consumer. FIG. 5D shows the optional sombrero hanging hole 111 and the optional die cut window 112. A first portion 118 of the interior side 116 has a heat seal adhesive 117 such as Solucote 105li-3-45, a plastic film such as PET or polypropylene or other type of heat seal adhesive typically used for blister or heat seal packaging. A second portion 119 of the interior side 116 has no adhesive coating.

Referring to FIG. 5B, the front carrier 110 is vertically placed over the transaction card 120 and the activation device 130 so the first portion 118 which has the adhesive 117, does not impinge on the transaction card 120 but does impinge on the activation device 130. When the adhesive is cured with a curing energy or method, e.g., with heat, pressure, UV light, ionizing radiation, or other energy or method, the front surface 131 of the activation device 130 including the activation elements thereof, adheres to the front carrier 110. Alternatively, a permanent adhesive may be used in a continuous seal or bond about the perimeter of at least the transaction card of the assembly 140. Attempts to tamper with the package may result in fibers being torn off the front carrier 110 and/or back carrier 160, in a manner that be apparent to the consumer or the third party retail store personnel. In addition with no adhesive impinging on the transaction card, because there is no adhesive in area 119 of the front cover 110 and in area 169 of the back cover, even after long periods of time in hot storage, transportation, and display environments, the front carrier 110 is less likely to adhere permanently to the transaction card 120 and the back carrier 160 is less likely to adhere permanently to the transaction card 120.

Referring to FIG. 5E, an exterior surface 165 of the back carrier 160 may includes a sombrero hanger hole 161, a magnetic stripe 164, a die cut window 162 to reveal the activation device 130 including activation elements or other features, which may include graphics, or bar codes contained with or on the activation device 130. Perforations 163 to the back carrier 160 make it easier for the consumer to open the package assembly 100 and remove the transaction card 120. The exterior surface 165 of the back carrier 160 typically contains graphics and text that provide information on the transaction card 120 contained within the package assembly 100. The magnetic stripe 164 is optionally encoded with activation data.

Referring to FIG. 5F the interior side 166 of the back carrier 160 is shown including sombrero hanger hole 161, perforations 163 and die cut window 162. A first portion 168 of the interior side 166 of the back carrier 160 is coated or covered with adhesive or heat seal film 167 in the same manner as the interior side 118 of the front carrier 110. A second portion 169 of the interior side 166 of the back carrier 160 has no adhesive or only a fugitive adhesive thereon. Referring to the finished package illustrated in FIG. 5B, the first portion 168 of the back carrier 160 is positioned so that it does not impinge the transaction card 120. The first portion 168 is also positioned so that it does impinge on the activation device 130. The first portion 168 is further positioned in such a way as it does impinge on the first portion 118 of the front carrier 110. When the adhesive is cured, the first portion 168 of the back carrier 160 will adhere securely to the activation device 130. Any attempt to remove the activation device 130 from the back carrier 160 will result in the tear of paper fibers and/or will damage, deface or otherwise alter the appearance of the activation device in a manner that will be apparent to a consumer or to store personnel at the third party retailer.

The second portion 169 of the back carrier 160 is positioned so that the transaction card 120 is directly impinged upon it in the finished package assembly 100. In this manner the transaction card 120 may be easily removed without adhesive residue from the finished package 100 adhering to it. In some variations, and with some manufacturing methods, it may be desirable to apply a removable fugitive glue (for example, HB Fuller HM 2703) to the transaction card 120 to hold the card assembly 140 in place when sealing the front carrier 110 and back carrier 160 to each other and to the activation device 130. Such fugitive glue is selected to prevent damage to the transaction card 120 or its surface, and is easily removed from the surface of the transaction card 120.

Referring to FIG. 5G back 105 of a completed package assembly 100 is shown where the transaction assembly 140 is packaged as shown in FIG. 5A. The activation elements in this example comprise the activation data bar code 180 and the activation account number 190 show through a die cut window 162 in the back carrier 160. The activation elements, activation data bar code 180 and/or activation account number 190 can be thus used to activate the transaction card without removing the transaction assembly 140, i.e. including transaction card 120 and activation device 130, from the package assembly 100 in which it is sealed.

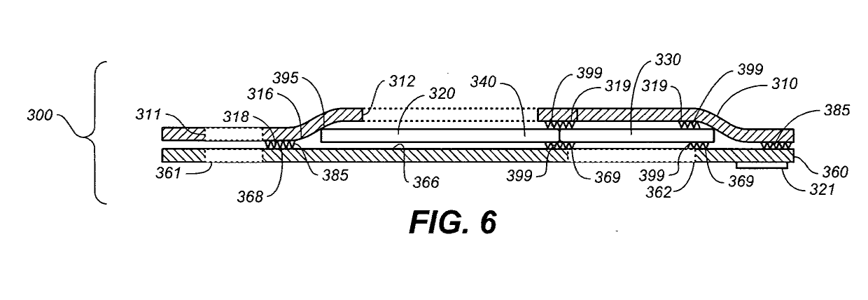

FIG. 6 is a variation of package assembly 300. The package assembly 300 includes a front carrier 310 and a back carrier 360 containing a transaction assembly 340. The transaction assembly comprises and activation device 330 with activation elements and a transaction device 320, e.g. transaction card. The front carrier 310 and back carrier 360 are constructed from material that can be effectively heated and melted to the point where the surfaces will weld together. Examples of such material may include PVC, Polystyrene, PET-G, polypropylene and other materials. The heat can be applied through a heated metal or ceramic element or through an ultrasonic or radiofrequency heater or other curing energy source. The energy may applied to heat or form a bond or seal 385 at an area 318 of the interior surface 316 of the front carrier 310 and an area 368 of the interior surface 366 of the back carrier 360 that do not touch the transaction card 320. Such bond or seal 385 may be a continuous seal about at least the transaction card 320 of the transaction assembly 340. Energy is also applied to heat or form a bond or seal 399 at areas 319, 369 of the interior surfaces 316, 366 of the front and back carriers 310, 360 respectively that touch the activation device 330. Accordingly, the front carrier 310 and back carrier 360 are bonded, sealed or coupled together to form an enclosure 395 and to thereby secure the activation device 330 to the front carrier 310 and back carrier 360. Evidence of tampering may be apparent for example if the front carrier 310 and/or back carrier 360 are broken to access the card 320. In FIG. 6, the front carrier 310 may have a sombrero hole 311 and a die cut window 312. The back carrier 360 in FIG. 6 shows a sombrero hole 361, a magnetic stripe 321 and a die cut window 362.

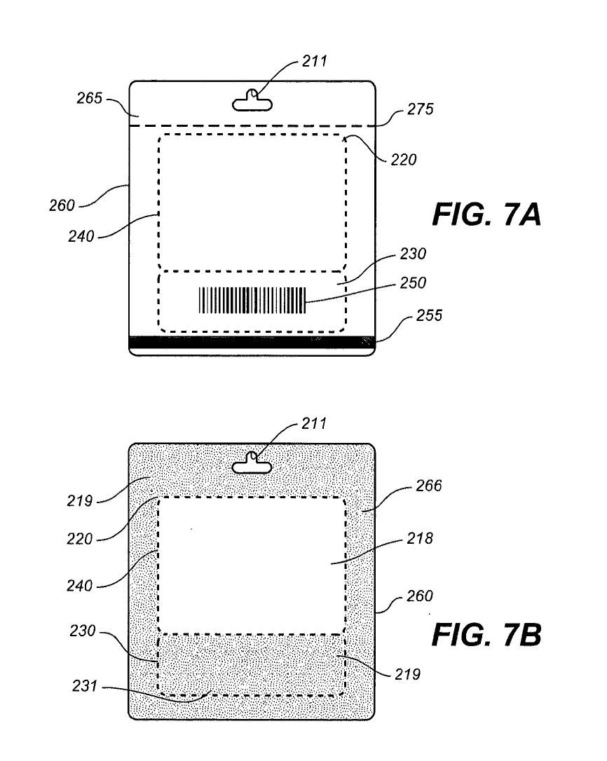

FIGS. 7A and 7B illustrate a variation of a back carrier 260 that may be used in a package such as a package assembly described herein. Referring to FIG. 7A an exterior side 265 of the back carrier 260 is shown with an activation element 250, e.g., a unique activation bar code printed thereon, containing activation information corresponding to the transaction card 220 that is to be enclosed inside a finished package assembly. Another activation element 225 may comprise, e.g., magnetic stripe that may also be encoded with unique activation data corresponding to the transaction card 220. A perforation 275 has been added to the back carrier 260 to allow the consumer to remove the card after purchase.

As shown in FIG. 7B, the interior surface 268 of the back carrier 260 includes first portion 219 where adhesive has been applied prior to sealing and a second portion 218 where there is no adhesive. The portion 218 with no adhesive is positioned next to the transaction card 220 of assembly 240, in assembling the final package. A tamper indicator 230 of the assembly 240 is coupled to the transaction card 220 in a similar manner as the activation devices herein are attached to transaction cards. As shown in FIG. 7B the tamper indicator 230 has adhesive applied to its front surface 231. Thus, the transaction card 220 to be removed easily without adhesive residue and without damaging the transaction card 220 upon removal while the tamper indicator remains behind coupled to a front carrier such as a front carrier described herein. If a transaction card has been removed from the packaging it would be evident or apparent due to damage to the package or the tamper indicator 230. The back carrier may also have a die cut sombrero hole 211 and a perforation 275 to assist the consumer in opening the package after purchase.

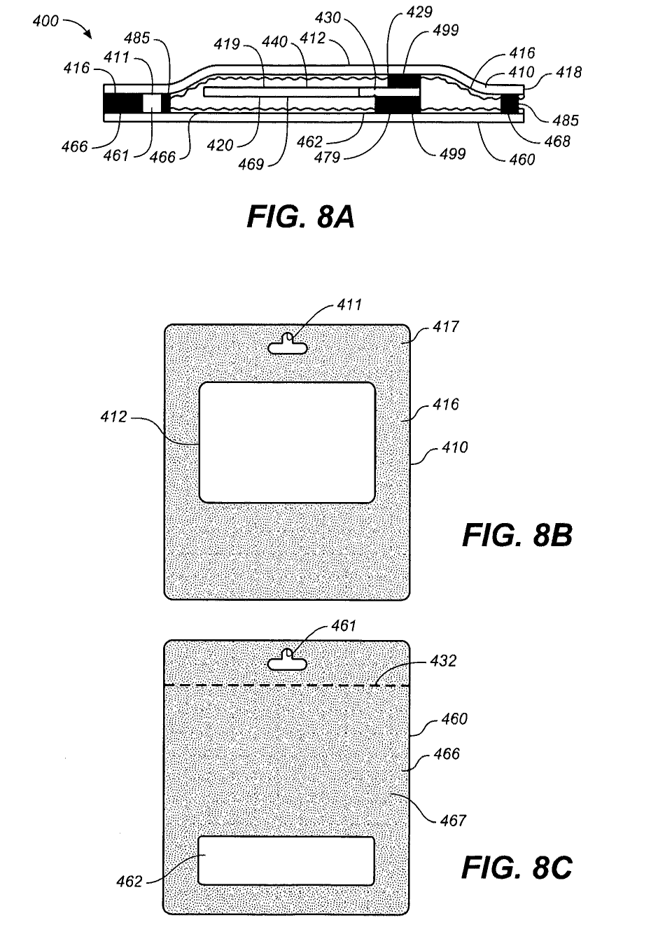

Referring to FIGS. 8A to 8C, package assembly 400 comprises a front carrier 410 and a back carrier 460 with a transaction assembly 440 comprising a transaction card 420 and activation device 430 (e.g. similar to those described with respect to FIGS. 1-4), contained between the front carrier 410 and back carrier 460. The interior side 416 of the front carrier 410 has an overall coating of heat seal adhesive or heat sensitive film 417. The front carrier 410 also comprises a sombrero hole 411 and a die cut window 412 for revealing a portion of the front of the transaction assembly 440. As shown in FIG. 8C, of the interior side 466 of the back carrier 460 of is coated a with a heat seal adhesive or heat sensitive film 467. The back carrier 460 also comprises a sombrero hole 461 and a perforation 432 for assisting in opening the package 400, and a die cut window 462 for display or revealing at least a portion of the activation device 430.

Referring to FIG. 8A, the front carrier 410 and back carrier 460 are sealed or bonded together at areas 418 and 468 to form a relatively continuous seal or bond 485 about at least the transaction card 420. Heat or curing radiation or energy is applied to areas 418, 468 of the front carrier 410 and back carrier 460 that do not touch the transaction card 420. Additionally, heat or curing radiation or energy is applied to areas 429, 479 of the front carrier 410 and back carrier 460 respectively that touch the activation device 430 forming an adhesive bond or seal 499 between the front and back carriers 410, 460 and the activation device 430. No heat or curing radiation is applied to the area 419 of the front carrier 410 or area 469 of the back carrier 460 that impinge on the transaction card 420. Where the front carrier 410 and back carrier 460 impinge on each other the adhesive bond or seal 485 is formed which prevents a potential thief from having undetected access to the transaction card 420 The transaction card 420 is free from a permanent bond or bond that would cause damage, or destruction to the transaction card or its appearance. Fugitive glue may be used to hold the transaction card temporarily in place attached to the carriers 410, 460. The activation device 430 is coupled or bonded to the carriers 410, 460 in a manner that would change or damage the activation device, the carriers 410, 460 or their appearance if removed from the package 400.

While the examples herein have been illustrated and described, it should be understood that various changes, adaptations, and modifications may be made therein without departing from the spirit of the invention and the scope of any claims hereto.

1. A transaction device assembly package comprising:
a transaction device comprising a unique usage element having a unique account associated therewith;
an activation device removably coupled to the transaction device, the activation device comprising a unique activation element associated with the transaction device;
a carrier package comprising a front carrier and a back carrier and at least one bond between the first front carrier and second front carrier forming an enclosure between the front carrier and the back carrier containing said transaction device and activation device;
wherein at least one of said interior surface of said front carrier and interior surface of said back carrier is bonded to the activation device.

2. The transaction device assembly of claim 1 wherein the at least one of said interior surface of said front carrier and interior surface of said back carrier is bonded to the activation device with a permanent adhesive.

3. The transaction device assembly of claim 1 wherein the at least one of said interior surface of said front carrier and interior surface of said back carrier is bonded to the activation device with an energy formed seal.

4. The transaction device package assembly of claim 1 where the back carrier further comprises an opening revealing the activation element on the activation device.

5. The transaction device package assembly of claim 4 wherein the back carrier comprises an exterior surface and a magnetic strip on the exterior surface wherein the magnetic strip comprises account activation information correlated to the transaction device.

6. The transaction device package assembly of claim 1 wherein the activation device is bonded to the package assembly in a manner that tampering will cause visible damage or deformation to the bonded activation device or packaging.

7. The transaction device assembly of claim 1 wherein the front carrier and the back carrier each comprise a weldable material
wherein the front carrier is bonded to the back carrier around a perimeter of the front carrier and back carrier.

8. The transaction device assembly of claim 1 wherein the front carrier comprises a front interior surface and wherein the back carrier comprises a back interior surface wherein each at least one of the front interior surface and back interior surface comprise an adhesive thereon wherein the front carrier and the back carrier are attached with an adhesive to the activation device.

9. A transaction device assembly a transaction device comprising a unique usage element having a unique account associated therewith;
a tamper indication structure removably coupled to the transaction device,
a carrier package comprising a front carrier and a back carrier and at least one bond between the first front carrier and second front carrier forming an enclosure between the front carrier and the back carrier containing said transaction device and tamper indication structure;
wherein at least one of said interior surface of said front carrier and interior surface of said back carrier is bonded to the tamper indication structure.

10. The transaction device assembly of claim 9 wherein the at least one of said interior surface of said front carrier and interior surface of said back carrier is bonded to the tamper indication structure with a permanent adhesive.

11. The transaction device assembly of claim 9 wherein the at least one of said interior surface of said front carrier and interior surface of said back carrier is bonded to the tamper indication structure with an energy formed seal.

12. The transaction device assembly of claim 9 wherein at least one of the front carrier and the back carrier comprises an activation element on the exterior surface and correlated to the transaction device.

13. The transaction device package assembly of claim 12 wherein the account activation element comprises a magnetic strip comprising account activation information correlated to the transaction device.

14. The transaction device package assembly of claim 1 wherein the tamper indication structure is bonded to the package assembly in a manner that tampering will cause visible damage or deformation to the bonded activation device or packaging.

15. The transaction device assembly of claim 1 wherein the front carrier and the back carrier each comprise a weldable material
wherein the front carrier is bonded to the back carrier around a perimeter of the front carrier and back carrier.

16. The transaction device assembly of claim 1 wherein the front carrier comprises a front interior surface and wherein the back carrier comprises a back interior surface wherein each at least one of the front interior surface and back interior surface comprise an adhesive thereon wherein the front carrier and the back carrier are attached with an adhesive to the tamper indication structure.

17. A method of packaging a third party transaction device assembly comprising a transaction device and an tamper indication structure coupled to the transaction device comprising:
providing a package comprising a front carrier and a back carrier and providing at least one of an inside surface of front carrier and an inside surface of a back carrier with an adhesive thereon
sealing the transaction device and tamper indication structure between the front carrier and the back carrier; and
bonding the package to the tamper indication structure in a manner that tampering will cause visible damage or deformation to the bonded activation device or packaging.

18. The method of claim 17 wherein the bonding the package to the tamper indication structure comprises bonding tamper indication structure to the first carrier and the second carrier at substantially the same time.

19. The method of claim 17 wherein the step of sealing the transaction device and tamper indication structure between the front carrier and the back carrier comprises sealing an activation device between the front carrier and the back carrier.

20. The method of claim 19 further comprising encoding an activation element on the activation device to correlate the activation device with the transaction device.
